(19) United States
(12) Patent Application Publication
(10) Pub. No.: US 2010/0299193 A1
(43) Pub. Date: Nov. 25, 2010

(54) Community-Based System and Method for Automatic Discount of a Purchase

(76) Inventors: Hilda S. Cosman, Montgomery, TX (US); Bryan A. Jourdan, San Antonio, TX (US)

Correspondence Address: THE MATTHEWS FIRM, 2000 BERING DRIVE, SUITE 700, HOUSTON, TX, 77057, US

(21) Appl. No.: 12/469,739

(22) Filed: May 21, 2009

(51) Int. Cl. G06Q 30/00; G06Q 50/00; G06F 17/30; G06Q 10/00

(52) U.S. Cl. 705/14.13; 705/26; 705/27; 705/30; 707/E17.014; 707/E17.017

(57) ABSTRACT

A community-based system and method for providing automatic discounting of a purchase is described. A database containing a plurality of items for purchase and a plurality of discounts associated with the items is provided. A search query is received from a user using a networked device, and items responsive to the search query are transmitted to the device for display. The device is then usable to select one or more displayed items. Corresponding discounts are automatically associated with the selected items, and when purchase of the item is completed, the associated discounts are applied in a paperless manner. Concurrent with the discount feature, users are permitted to create customizable user accounts, through which favorite items and groupings of items can be uploaded, flagged, stored, and shared with other users. User accounts are usable for tracking of demographic information, communication with other users, and providing automatic notifications based on user-selected preferences.

### FIELD

The present invention relates, generally, to a paperless, community-based system and method for discounting a purchase at a physical or virtual location through automatic application of store-provided discounts, discounts provided by a manufacturer, distributor, promoter, supplier, vendor, or any third party associated with one or more services or products, or any other discounts associated with items selected by a purchaser.

### BACKGROUND

Periodically, the economies of various nations, and even the worldwide economy as a whole, experience periods of decline. Even during times of comfort and economic gain, most consumers are very willing to undertake measures to reduce personal and household expenses. However, during times of economic downturn, when household incomes are diminishing at the same time prices for commonly used items are increasing, these measures are much more diligently pursued.

One common method for reducing expenses for everyday items is the use of coupons. Typically, various stores, manufacturers and/or distributors, providers of products and/or services, suppliers, promoters, vendors, and other third parties associated with goods or services, provide printed coupons, contained within various publications, these coupons offering discounts for certain goods or services. Use of these printed coupons requires consumers to acquire appropriate printed publications, which can include newspapers, magazines, advertisements produced by one or more stores, booklets of coupons, or similar printed materials. A consumer must then skim the publications to locate coupons he or she intends to use, cut out and store the coupons in an organized fashion, locate the corresponding items at a store, business, or similar location, presuming the items are available at that location and the coupons are accepted at that location, compute the discounted price and compare the discounted price to that of competing brands or similar products, then present both the items to be purchased and the corresponding coupons when leaving the purchase location.

While surveys generally indicate that approximately 67% of consumers are more likely to use coupons during a recession, the use of printed coupons is a tedious, time-consuming, archaic endeavor. Similar surveys indicate that approximately 77% of consumers would be more likely to utilize paperless coupons than printed varieties.

Responsive to this information, many manufacturers and stores have made electronic coupons available via the Internet, however despite the available evidence, electronic coupons still constitute less than 1% of the total amount of coupons provided by stores and manufacturers. To utilize electronic coupons, a computer-savvy consumer is intended to search for electronic coupons, then print these coupons for use at a store in the same manner as a conventional printed coupon. While locating and printing electronic coupons is far more convenient than skimming printed materials to find paper coupons, which must be physically cut from the printed matter, use of electronic coupons still requires a consumer to actively dedicate time to search for and locate coupons he or she intends to use, then print the coupons, which requires an available printer, paper, and ink, and the undertaking of the time, costs, and environmental impact associated with the use thereof. The coupons must then be stored in an organized fashion until use at a location that will accept the coupons, during a time when the coupons are acceptable at the location. Additionally, the consumer must still locate the corresponding items at a store or business, presuming the items are available, compute the discounted price, compare the discounted price to that of competing brands or other products, and present both the items and the corresponding coupons upon leaving the location. Further, many consumers lack the necessary computer skills to effectively locate and use electronic coupons. Thus, while electronic coupons are marginally less cumbersome to locate and acquire than conventional printed coupons, electronic coupons are still relatively tedious to print, store, and utilize. Additionally, the time and the cost of materials required for printing the electronic coupons, when factored against the available discount, mitigates the value of the coupons.

To eliminate many of the tedious physical steps, time, and costs required to utilize electronic coupons, some modern systems enable electronic shopping, through which items to be purchased can be selected electronically. Using a computer or a similar device, a consumer can search available items, select desired items electronically, then receive a list of available discounts relating to the selected items. However, a need remains for a system and method that seamlessly and automatically associate and apply discounts to purchased items without requiring such intermediate steps to be taken by the consumer.

With the advent of the Internet, the world has quickly entered an age where information of all types, relating not only to items for purchase and available discounts associated with those items, but various related and unrelated pieces of information, travels nearly instantaneously. Today, nearly any individual can claim a small region of cyberspace as his or her own, customize this region with personal preferences, and make all manner of chosen information available to one or more other individuals, or to the general public. Additionally, through use of the Internet, every time an item is purchased or a discount relating to an item is used, data relating to this purchase, the associated discount, or the purchaser can be stored, transmitted, and tracked. Further, many businesses today are able to provide Internet access to their customers, and make use of various in-store or in-business networks accessible to customers on the premises. No existing system effectively combines the community-based and demographic tracking potential of the Internet with the incentive of seamless, automatic, paperless discounts applied to purchased items, all of which is made possible through modern technology.

In light of the above, and in light of the foregoing disclosure, a need exists for a system and method that automatically discount a purchase of an item made at a location, without requiring numerous additional steps to be taken by the user to obtain the discount at an acceptable location during an acceptable time period, other than purchasing the item.

A further need exists for a system and method that enable a user to flexibly and reliably select desired items for purchase through a variety of searching means, including searching for available items, or groupings of items, by name, brand, or through identifying information such as flags, categories, or associated communities, such as cooking, automotive, etc.

A need also exists for a system and method that provides users with access to a community environment, enabling users to create customizable personal accounts for efficient and simple access to a single searchable source for discounts of all kinds, relating to all manner of goods and services. The community environment can also enable users to share favorite items, related events, personal interests, or other personal information related or unrelated to discounts received and purchases made, with other users or with the general public, as well as to vote or rank various items or groupings of items, to submit commentary, and to communicate with other users.

The present invention meets these needs.

### SUMMARY

The present invention relates, generally, to a method for automatically discounting a purchase at a location, such as a grocery store, a retail store, a restaurant, a tourist attraction, an event venue, or another business or similar location where goods and/or services can be purchased. The present invention advantageously provides a single source where a user can create a customizable user account, or access the system as a “guest” user, and flexibly and efficiently search and locate items and corresponding discounts from multiple sources using a large variety of searching methods, while enjoying the benefits of a community-based application where favorite items, searches, discounts, and other elements of personal information can be stored and selectively shared with other users.

One exemplary embodiment of the present invention is adapted for use in grocery stores and similar locations that acquire food, drink, and similar products, including cleaning products, paper goods, cooking utensils and bakeware, and similar items, from manufacturers and distributors, then offer such products for sale. Throughout the disclosure herein, this exemplary embodiment will be referenced to further describe one or more features of the present invention, however, it should be understood that the present invention is applicable to the purchase of any good or service, including but not limited to retail goods, personal or commercial services, hotel stays, admission to tourist attractions or event venues, or meals at restaurants. It should further be understood that the present invention is also usable for the purchase of goods and services at a virtual location, such as when making a purchase from an Internet-based site using a home computer.

Through use of a networked device, in communication with a database, a user can submit a search query to obtain a list of items from the database. The database contains a plurality of items for purchase and a plurality of discounts, each discount associated with at least one of the items. While the specific form of the networked device can vary, in an embodiment of the invention, the networked device can include a user-provided portable device, such as a cellular telephone, a personal digital assistant, a palm-top computer, a laptop computer, or a similar portable device owned and carried by the user, able to wirelessly communicate with the database. Such a portable device can be used to locate discounts for items while the user is in a store, business, or similar location where the user intends to make a purchase, or the device can be used to access the database remotely while the user is elsewhere.

In an alternate embodiment of the invention, the device can be a portable device provided to users upon entry into a store, business, or similar location, the portable device being in wireless communication with the database using the Internet or a similar in-store or in-business wireless network. Such a device can include a display screen and one or more input devices, such as a keyboard or keypad, a mouse or trackball, a touch screen, or similar devices usable to select and/or manipulate displayed items and input search queries and other information. The portable device can also include attachment members for convenient mounting or attachment while shopping, such as clips for securing the portable device to the handle of a shopping cart. The portable device can also include a wireless security device or similar system usable in combination with detectors at store exits, internal tracking devices, or similar security measures to prevent theft of the device or unintended removal of the device from the location.

In a further embodiment of the invention, the networked device can include a device remote from a store, business, or other location where a purchase is to be made, such as a personal home or business computer, thereby enabling a user to input search queries relating to items for purchase from home or another remote location. Generally, any device having sufficient wired or wireless transmitters, receivers, and/or other circuitry, hardware, or software to establish a networked connection with the database can be used to submit a search query.

The search query received from the networked device can utilize a variety of search terms, fields, categories, flags, or other methods by which the database can be searched. Typically, a user can enter terms relating to a type of item desired, or a brand or manufacturer of a desired item, and responsive to the search query, a list containing one or more items that comply with the query is transmitted to the networked device for display. In addition to searching for specific types of items or brands of items, in an embodiment of the invention, a user can enter a search query relating to a specific grouping of items.

For example, a user utilizing an embodiment of the present invention relating to grocery stores, food, and cooking could input a search query for a recipe, or a specific event where food will be served. Following this example, a user hosting a Super Bowl party could enter a search query relating to this event, and a list of popular recipes, decorative items, and/or paper goods pertaining to the event could be transmitted to the networked device for display. Similarly, a user could also enter a search query relating to chili, or a seven-layer bean dip, and a list of popular recipes responsive to the query would be transmitted for display. Searching for recipes by other categories, including ethnic categories, such as Italian, or dietary categories, such as diabetic or low-carb, can also be enabled. The device can then be used to input a selection of a listed recipe or similar grouping of items. For example, after displaying a list of recipes responsive to a search query and receiving selection of a displayed recipe, a list of items necessary to prepare the selected recipe can be displayed, similar to a list of available items that could be obtained by searching specifically for a type or brand of item.

Similarly, a user could enter a search query relating to any grouping of individual items, such as a specific make and model of automobile, the portable device then receiving and displaying a list of parts, materials, and/or services relating to that vehicle. Likewise, upon selection of a similar grouping of items, a list of sub-groups of items or individual items can be provided, enabling a user to drill down into the obtained search results until a list of individual products for purchase is obtained. It is to be understood that the present method is usable to locate items and corresponding discounts for any good or service, relating to any industry, at any location, including virtual, Internet-based locations.

The present method then includes receiving a selection of one or more of the displayed items from the networked device. For example, a user utilizing the embodiment of the present invention relating to grocery stores, food, and cooking, as described above, who is already in possession of multiple ingredients necessary for a selected recipe may wish to purchase only certain items from the displayed list. By inputting selections of items spanning all interests, categories, and/or industries into the device, performing multiple searches as necessary to list each desired item, the user can create a virtual shopping list.

The selected items are then automatically associated with one or more corresponding discounts from the database. This association of applicable discounts with selected items is automatic and paperless, occurring without requiring specific input by the user. The discounts can include store-provided discounts, manufacturer-provided discounts, distributor-provided discounts, discounts provided by other providers or promoters of products, or other similar types of discounts from any party associated with any good or service. This association of the discounts with applicable items can be seamless and invisible to the user, requiring no action or selection by the user. However, in an embodiment of the invention, one or more of the corresponding discounts can be transmitted to the networked device for display, thereby notifying the user of the existence of the discounts to encourage selection of certain items, and serving the dual purpose of promoting awareness of certain items or brands, similar to an advertisement.

In a preferred embodiment of the present invention, at least a portion of the discounts in the database can be provided to the database directly by a third party issuer/provider of the discount. Third parties can access the database using a networked device and upload discounts using a standardized or customized format. By permitting third parties to provide their own set of discounts associated with their products, and to selectively remove from the database discounts and/or products that are no longer applicable, very little labor is required by an administrator to maintain or update the database.

Manufacturers, promoters, suppliers, distributors, vendors, and/or other third parties can also be permitted to purchase space and upload advertisements relating to specific items and/or specific companies or other entities associated with goods or services. Advertisements can include text, graphics and/or banners, a selectable element through which a user can select an item for purchase, or other similar advertisements. In an embodiment of the invention, the list of items responsive to the search query can be arranged in a manner representative of purchased advertisements or premiums paid by one or more third parties. For example, when a list of items is displayed, those items associated with manufacturers or other parties who have paid a premium can be listed first, before other items. Alternatively or additionally, items can be listed in order of decreasing advertising dollars received. Other orders for the list of items are also usable, such as displaying items in order of lowest price to greatest price, accounting for any applicable discounts, or displaying items in an order based on user votes, rankings, flags, or other preferences indicated by users of the present invention.

Advertisements can also include textual, graphic, and/or selectable prompts provided to users when certain search queries are entered and/or when certain related items are selected by the user for purchase. For example, a user utilizing the embodiment of the present invention relating to grocery stores, food, and cooking could select a recipe for crème brulee, and the database could output an advertisement for a kitchen blowtorch or other utensils necessary for preparation of the recipe, or the user could input a search query for lasagna, and the database could output advertisements for garlic bread and salad ingredients, or related recipes.

While the present method can be utilized to facilitate discounted purchase for any user, as a “guest” user, using any networked device in communication with the database, in a preferred embodiment of the invention, users can be permitted to create customizable user accounts. The present method can include accepting account information from the user, such as a user name, password, and selected personal information, which can include text, images, or combinations thereof, to form an account. The user account can then be accessed by the user each time the user intends to input a search query and select items for purchase. As items are purchased by the user, account information and/or demographic information relating to the user can be transmitted to one or more interested stores, manufacturers, distributors, promoters, advertisers, or to any other third party. Additionally, as purchases and discounts specific to each user account are tracked, in an embodiment of the invention, user accounts can accrue “points” or another form of virtual currency, usable to receive special products or merchandise and/or additional discounts beyond those normally available in the database. Users could be provided with a virtual “savings card” associated with their user account, used to track these points, or use user purchases and points could be tracked through other similar means.

Additionally, each user can be permitted to access his or her user account from any location, using a personal computer or similar device, through which the user can select favorite items, groups of items, events relating to certain items, etc., and flag or store these items in association with the user account. Users can also input customized information, such as personal interests or other information, personal favorite items, events, groups of items (i.e. favorite recipes containing multiple ingredients); upload information; or select items of preexisting information for association with their account. For example, in the embodiment of the present invention relating to relating to grocery stores, food, and cooking, users can be provided with a standardized form for submission of recipes to be associated with their user account, to be shared with other users or with the general public, thereby ensuring that each recipe stored within the database can be viewed or printed by all users using a uniform format.

Selectively, each user can make pieces of information and other media available for access by other users, thereby enabling each user to share favorite items, groups of items, virtual shopping lists, elements of personal information, photographs, streaming video, or combinations thereof, with other users. Users can thereby view and search information shared by other users. Users can also be permitted to send communications to other users, which can be stored in association with the destination user's account until read and deleted. Users can further input comments, reviews, or other information to be stored in association with one or more items of another user's account.

In addition to information shared by users, various publicly available sources of information can be stored in the database or placed in communication with the database for access by other users. For example, in the embodiment of the present invention relating to grocery stores, food, and cooking, recipes provided by manufacturers, stores, distributors, food-related publications and other media sources, and other similar sources and repositories, can be provided for user access. In this embodiment of the invention, users having accounts could be permitted to vote in favor of recipes, rank or rate recipes, submit commentary and/or reviews of recipes, or flag recipes as favorite recipes. Users searching for recipes can be provided with a listing of recipes that conform to the search query, wherein the recipes are displayed in decreasing order of popularity, as determined by user votes, ratings, and/or the number of users who have flagged the recipe as a favored recipe. It should be understood that similar features relating to user voting, ranking, commentary, flagging, and listing based on user votes can be applied to any categories of items.

In an embodiment of the invention, users can be permitted to select various items from the database and store the items in an organized format for personal retrieval, such as by saving a virtual shopping list for future access. For example, in the embodiment of the present invention relating to grocery stores, food, and cooking, a user can be permitted to select various recipes and create a schedule indicating intended meals to be prepared, forming a weekly menu. Organization of selected recipes in this manner can facilitate organized purchasing of groceries and other items by a user on a periodic basis, such as weekly, enabling a user to preplan meals for a period of time.

The present method can include providing periodic and/or automatic notification to user accounts that meet certain criteria. For example, if a user has flagged a specific item as a favorite item, a notification can be transmitted to the associated user account when special discounts or sales are applicable to the flagged item or other items related to the flagged item.

The present invention also relates, generally, to a system through which the above method is performed. The system includes one or more databases containing one or more of items for purchase and a one or more discounts, each associated with at least one of the items. The one or more databases further contain account information associated with a user to form a user account, and one or more items of stored information, such as selected and/or flagged items from the database, photographs, streaming video, text, messages, and/or personal information, stored in association with the user account.

The system further includes computer instructions for receiving a search query from a device in communication with the one or more databases and transmitting a list of individual items and/or groups of items responsive to the search query, computer instructions for receiving a selection of one or more items, and computer instructions for automatically associating and applying one or more corresponding discounts to at least one of the selected items.

One or more networked devices, in communication with the one or more databases, is usable to submit search queries, to access, provide, and modify account information and/or information stored in association with a user, or combinations thereof. One or more administrative devices, such as computers operated by manufacturers, distributors, or other suitable third parties, in communication with the one or more databases, can be used to access, provide, and/or modify the plurality of items and the plurality of discounts stored within.

The present system and method thereby provide a fully integrated, community-based system through which users can search for selected or favorite items, brands, or any other goods or services, using flexible search queries that can include various categories or flags, using any manner of networked device, including personal home or business computers, portable devices, such as cellular telephones or personal digital assistants, store-provided networked portable devices, or any type of networked input device used in conjunction with a display device, such as a home telephone used to manipulate items viewed on a television. Selected items are then automatically discounted, without requiring an excessive number of additional steps by the user, using a plurality of stored discounts, which can be provided directly by manufacturers, distributors, businesses, or other third-party providers of discounts, to minimize any required administrative labor to maintain or update the database.

Combined with the automatic discount feature, the present invention further enables users to share and obtain public, personal, and/or other customized information, communicate with other users, and personalize a flexible and customizable user account for a wide variety of purposes. The present invention also combines the aforementioned automatic discount and community features with an exceptional ability to provide manufacturers, distributors, sponsors, vendors, and other third parties with demographic information and targeted advertising opportunities.

In use, the present invention provides users with a simple, efficient, portable, local and/or remote method by which automatic, paperless discounts can be obtained for any desired good or service available from any physical or virtual location. The present system and method enable any user, including users having a personal user account and “guest” users, to enter any business, activate a user-owned or business-provided portable device, retrieve any previously stored discounts if applicable and/or contemporaneously search for applicable discounts, the complete the purchase of any corresponding items while the applicable discounts are automatically applied.

The present invention thereby overcomes the drawbacks of existing discount systems by providing an efficient, automatic, customizable, community-based system and method.

### BRIEF DESCRIPTION OF THE DRAWINGS

In the detailed description of the embodiments of the invention presented below, reference is made to the accompanying drawings, in which:

FIG. 1 depicts a diagram of an embodiment of the present system.

FIG. 2 depicts an embodiment of a portable device usable with the present system and method.

FIG. 3 depicts a diagram of an embodiment of the present method.

Embodiments of the present invention are detailed below with reference to the listed Figures.

### DETAILED DESCRIPTION OF THE EMBODIMENTS

Before explaining the described and depicted embodiments of the invention in detail, it is to be understood that the present invention is not limited to the particular embodiments described and depicted and that the present invention can be practiced or carried out in various ways.

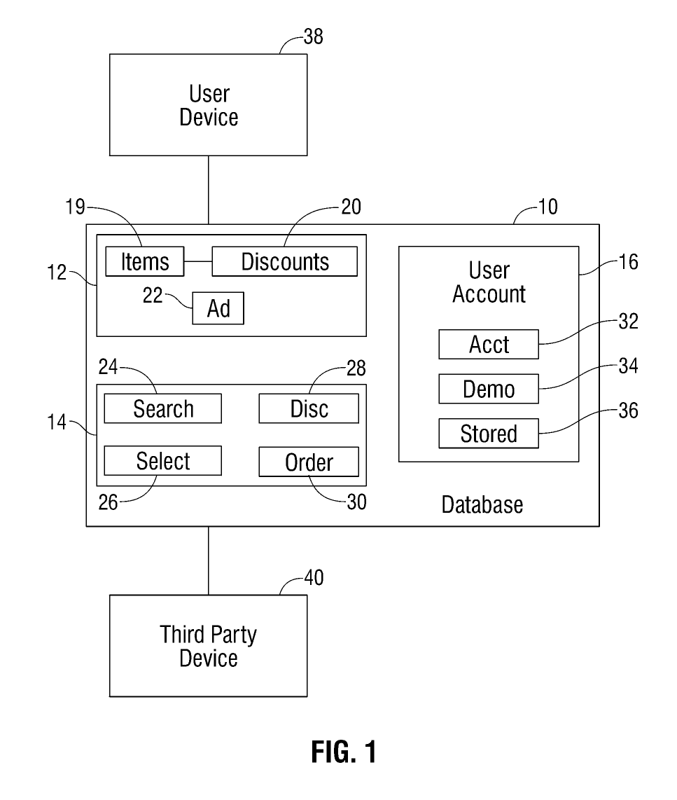

Referring now to FIG. 1, a diagram of an embodiment of the present system is depicted.

The present system is shown including a database (10), containing a variety of information and computer instructions. While FIG. 1 depicts a single database (10), it should be understood that the database (10) can include any type of data storage medium or related devices able to store, receive, and transmit data, and any number of identical or differing types of data storage media. The term “database” as used herein is synonymous with any single data storage medium or any combination of fixed, portable, remote, or local data storage media. The database (10) can be understood to include a server or other data storage media and related hardware, sufficient operational software, a database management system, or similar programs usable to manipulate data within the database (10) and the database (10) itself.

The database (10) is shown containing an information module (12), an execution module (14), and an account module (16). It should be noted that these modules (12, 14, 16) are merely exemplary divisions of the contents of the database (10), and that any information or computer instructions stored within the database (10) can be organized or partitioned in any manner, among any combination of data storage media.

The information module (12) is depicted including a plurality of items (19), stored in a manner such that each of the items includes one or more searchable terms, fields, flags, and/or categories, thereby enabling one or more of the items to be readily retrieved responsive to a search query that targets specific terms, fields, flags, and/or categories. The plurality of items (19) can include any type of individual item, or any grouping of multiple items. For example, the plurality of items (19) can include individual products for sale at one or more stores or other businesses, one or more groups of items, each including a collection of individual items, or combinations thereof. The term “item” as used herein, includes any single piece of information or grouping of multiple pieces of information stored within the database (10) in a manner that is searchable and retrievable responsive to a search query. Each item can relate to a product of any kind, a service, or any groupings of related or unrelated goods and/or services.

The information module (12) is also shown containing a plurality of discounts (20), stored in association with the plurality of items (19), such that each discount corresponds to at least one of the items, and possibly more than one of the items. Alternatively or additionally, one or more of the discounts can correspond to a particular category of item, such as all items having the same brand or originating from the same source, or all items containing a particular flag, field, or search term.

The information module (12) is further shown containing one or more advertisements (22), which can include textual advertisements, graphic or video advertisements and/or banners, links, or other features that can be selected by a user to acquire additional information about an item or manufacturer or to indicate an intent to purchase an item, or other similar types of advertisements. For example, when displaying a selected item or a selected discount corresponding to the item, the display can include a textual or graphic advertisement, such as a manufacturer's logo or positive information about a product or a discount. In an embodiment, of the invention, the advertisements (22) can be associated with the plurality of items (19) and/or the plurality of discounts (20), such that accessing one or more of the items or discounts also accesses a corresponding advertisement and/or an advertisement for a related item. Thus, when selecting a desired item, an advertisement for one or more related items can be automatically displayed.

The execution module (14) is depicted containing a plurality of computer instructions used to control and provide access to the contents of the database (10), receive user, administrative, and third party input, and provide output responsive to the input. In addition to the specific computer instructions described herein, it is to be understood that the execution module (14) can also include necessary operational software and programs for establishing and maintaining network connections, providing a user interface, receiving input, and providing output.

Specifically, the execution module (14) is shown including search query computer instructions (24), which instruct a local or remote processor to receive a search query and transmit a list of items responsive to the search query. The search query computer instructions (24) are adapted to receive any search terms, fields, flags, categories, or other types of identifiers provided in the search query that are related to each of the items, search the plurality of items (19) to identify these identifiers, then output a list of items that comply with the search query.

In conjunction with the search query computer instructions (24), the execution module (14) is shown containing ordering computer instructions (30), which can cause the outputted list of items to be arranged in a selected order. The selected order can vary depending on the search query and the items obtained, but can include listing items in a price-dependent order, in a customized order, in an alphabetic order, and/or in an order dependent upon advertising dollars or premiums received from manufacturers, stores, distributors, or other third parties associated with one or more items. The ordering computer instructions (30) can be adapted to order the outputted list of items in a differing manner depending on the nature of the search query, the identity of user providing the search query, the items listed, or other characteristics.

The execution module (14) is further shown containing selection computer instructions (26), which are used to receive a selection of one or more items after outputting a list of items responsive to the search query. Selected items can be stored locally or remotely to form a virtual shopping list. In situations where the outputted list of items includes a list of groupings of items, rather than individual items, the selection computer instructions (26) can receive selections of item groupings and output lists of individual items or sub-groups of items responsive to this selection, enabling a user to drill down into the groupings of information, prior to receiving a selection of individual items for purchase.

The execution module (14) is also shown containing discount computer instructions (28), which search the plurality of discounts (20) to identify specific discounts that correspond to selected items, then automatically associate and apply the applicable discounts to the selected items. The discount computer instructions (28) can associate and apply corresponding discounts invisibly and seamlessly, however in an embodiment of the invention, identified applicable discounts can be output to ensure awareness of the discounts to be used.

While the execution module (14) is depicted containing numerous discrete sets of computer instructions (24, 26, 28, 30), it should be understood that the described computer instructions are a single exemplary division of the computer instructions usable to perform the functions of the present system. Any piece of software or combination of programs can be used to provide any of the described functionality to the system.

The account module (16) is depicted containing data and information related to user accounts maintained within the database (10). Specifically, the account module (16) is shown containing personal account information (32), which can include any information used to identify, classify, maintain, and/or manipulate user accounts, such as user names, passwords, and personal data (name, address, e-mail address, telephone number, and similar information) relating to the user with which the account is associated. Similarly, the account module (16) is depicted containing demographic information (34), which can include information relating to a user's nationality, ethnicity, socioeconomic status, age, marital status, sexual orientation, or any other information describing the user with which the account is associated.

The account module (16) also includes stored information (36), which can include any data or information input, created, modified, selected, flagged, uploaded, or retrieved by a user and placed in association with a user's account. The stored information (36) can include photographs, text, videos, favorite items or groupings of items, favorite manufacturers, distributors, or other sources of products, personal interests, or any other item of data selected for association with the account. In an embodiment of the invention, the stored information (36) can also include information provided by other users, such as communications or commentary posted in response to or in association with content associated with a user's account.

A user device (38) is shown in communication with the database (10). The user device (38) can include any type of device having a display and an input device, or being able to communicate with a separate display and/or input devices, and being able to establish communication with the database (10). Such devices include, without limitation, a portable device owned by the user, such as a cellular telephone or a personal digital assistant, a portable device specifically provided by a store, business, or other party for communication with the database (10), a remote device in networked communication with the database (10), such as a personal home or business computer, or any other device usable to exchange information with the database (10), including a telephone or other input device used in conjunction with a television or other display device.

While FIG. 1 depicts a single user device (38), it should be understood that the depicted system can be configured for simultaneous communication with any number of user devices, and any type of user device as described above.

A third party device (40) is also shown in communication with the database (10). The third party device (40) can include any type of device identical or similar to those described as usable user devices. Likewise, the present invention is intended for simultaneous communication with any number of third party devices.

In operation, an individual, such as a discount provider, using the third party device (40) can input at least a portion of the plurality of items (19) and a corresponding plurality of discounts (20) for transmission to the database (10) for storage and future access by users of the system. The third party device (40) can also be used to input one or more advertisements (22). The third party device (40) or a similar device can originate from a store or other retail location, a chef or restaurant, a product supplier, an event sponsor, a manufacturer or distributor, or any other individual or entity that would offer items for sale and/or corresponding discounts.

Similarly, a user using the user device (38) can input the account information (32) into the database (10) to form a user account, the demographic information (34) in association with the account, and can selectively provide any type or quantity of stored information (36) to customize the account.

The user device (38) can be used to submit a search query to the database (10), which causes the search computer instructions (24) to retrieve responsive items from the plurality of items (19) and display these items on the user device (38) and/or an associated display device in an order determined by the ordering computer instructions (30). The user device (38) can then be used to select one or more displayed items, which causes the selection computer instructions (26) to receive the selection and, if necessary, display subgroups or individual items when a larger grouping of items is selected.

The discount computer instructions (28) then automatically associate corresponding discounts with the selected items. In an embodiment of the invention, the corresponding discounts can be displayed on the user device (38) or an associated display device so that the user is aware of the applicable discounts.

Throughout the searching and selection process, one or more of the advertisements (22) can also be displayed on the user device (38) or associated display device responsive to specific search queries, selections, or independent thereof.

Once the purchase of the selected items is completed, the associated discounts are applied to the purchase price of the selected items. Completion of the purchase can occur by obtaining the selected items at a store and processing the items through a store scanner or similar device, or having a cashier or other store employee scan and/or process the items. For example, after selecting items using a networked device and having discounts automatically associated therewith, a user can be provided with a transactional identifier to be provided to a cashier or other store employee, who can input the identifier to access and apply the associated discounts to the items purchased. Discounts relating to any items selected but not purchased can be disregarded. In an embodiment of the invention, users having a personal user account can provide the cashier or other store employee with a user account name, enabling the store employee to retrieve any discounts associated with selections of items from that user account and apply the discounts to the items purchased. However, users having a user account can also receive a transactional identifier, as described above. In embodiments of the present invention where a store-provided networked device is used, a user can relinquish the device to a cashier or other store employee to enable the associated discounts to be processed, however in such embodiments, a unique transactional identifier could also be used, as described previously. Embodiments of the present invention also include completing Internet-based purchases, where a user can electronically provide account information or a transactional identifier when completing a purchase, thereby enabling any associated discounts to be applied to the purchases.

It should be understood that the described means by which discounts applicable to selected items are processed and applied are merely exemplary, and any manner by which the discounts can be processed and applied can be utilized under the scope of the present invention. Independent of the specific identifiers or other methods used to track the selected discounts associated with the purchased items, the present invention is able to paperlessly and wirelessly communicate the applicable discounts to the purchasing location and modify the purchase price of the selected items accordingly.

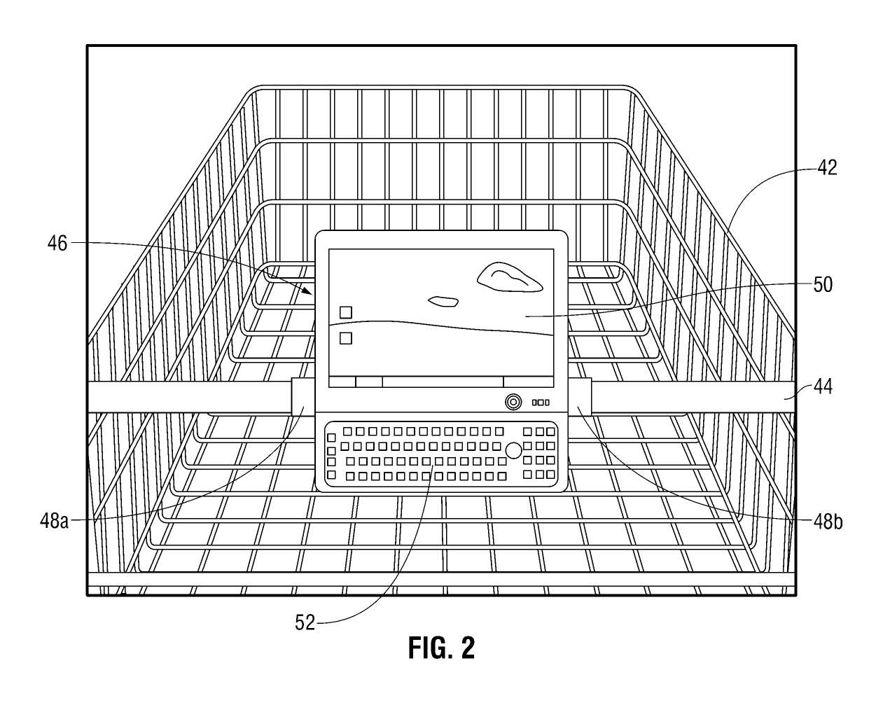

Referring now to FIG. 2, an exemplary embodiment of a business-provided portable device usable with the present system and method is depicted. The depicted device is usable in an embodiment of the present invention adapted for use within a grocery or retail store.

Specifically, FIG. 2 depicts a shopping cart (42) having a handle (44) for facilitating movement of the shopping cart (42) throughout the store. The depicted portable device (46) is adapted for attachment to the handle (44) using two attachment brackets (48a, 48b) configured to be securely clipped around the circumference of the handle. While FIG. 2 depicts two attachment brackets (48a, 48b), other numbers and other types of attachment members are also usable and can include clips, clamps, clasps brackets, straps, snaps, zippers, buttons, Velcro™, or any other usable fastener or engagement member able to attach the portable device (46) to the handle (44). While the depicted portable device (46) is shown removably attached to the handle (44), in an embodiment of the invention, the portable device (46) can be more permanently attached to the handle (44), such as through use of screws, nuts, bolts, or through welding or integral molding with the portable device (46) to the handle (44), or alternatively to the basket or other part of the shopping cart (42).

The portable device (46) is shown having a display screen (50) for displaying search results, advertisements, account information, and other similar data, and a keyboard or keypad (52) for inputting search queries and selecting displayed items. Other types of input devices, such as a mouse, a track ball, a touch screen, one or more selector buttons, or any other device able to input data into the portable device (46) can also be used.

The portable device (46) can include a processor; a local, remote, fixed, or removable data storage medium; and sufficient circuitry, software, and hardware to establish a networked connection with the database. In an embodiment of the invention, the processor of the portable device (46) can be used to execute the computer instructions contained within the database. In a further embodiment of the invention, the portable device (46) can have the required computer instructions stored within its data storage medium while accessing the plurality of items and discounts contained within the database remotely. Any combined use of integral or local data storage media contained within the portable device (46) and remote data storage media can be used with the present system and method.

While FIG. 2 depicts a store-provided portable device (46) for use within a grocery or retail store, it should be understood that the depicted portable device (46) is only one exemplary embodiment of a device usable with the present invention. Usable devices additionally include user-provided portable devices, such as cellular telephones or portable computers, and remote devices, such as personal home or business computers. Further, the devices used to access the database are not restricted to purchases from grocery or retail stores, but can be used to purchase any good or service from any physical or virtual location, including but not limited to retail stores, restaurants, hotels, tourist attractions, concert and sports venues, and Internet sites.

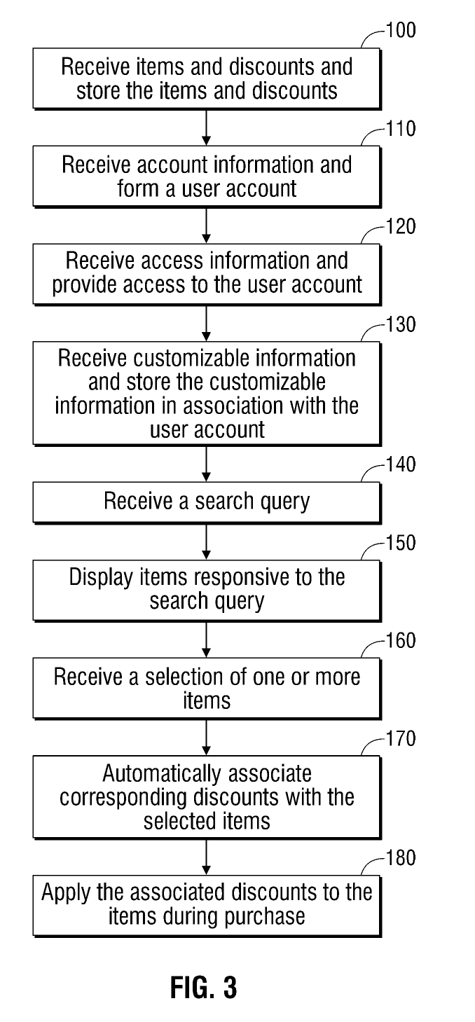

Referring now to FIG. 3, a diagram of an embodiment of the present method is depicted.

Specifically, the depicted method includes the step of receiving and storing items and discounts (100) for future use. A manufacturer, distributor, supplier, sponsor, or another third party, or a local administrator of a database usable with the present method can transmit a number of items available for purchase, and a variety of discounts, each associated with one or more of the items, for storage within a database or similar data storage medium. Each time the present method is performed, it is not necessary that this step be performed. The present method can include accessing and manipulating preexisting items and discounts without receiving additional and/or updated content from administrators and/or third parties.

The depicted method then includes the step of receiving account information to form a user account (110). Any user in communication with the database can submit sufficient information to form an account, such information including but not limited to a user name, a password, an address, an e-mail address, a telephone number, or other similar items of personal information. Users having preexisting user accounts are not required to provide account information each time the method is performed, in which case, the step of receiving account information to form the user account (110) can be omitted. Access information is then received, and access is provided to the user account (120).

Customizable information can then be received and stored in association with the user account (130). As described previously, customizable information can include any data or information, such as text, video, photographs or other graphic elements, favorite items or groups of items, personal information, or any other type of information. The customizable information can be selectively made available to one or more other users, to all users of the present method, or to the general public.

In a further embodiment of the invention, users can be permitted to access and utilize the database as a guest user, without creating a user account, in which case the steps of receiving account information (110), accessing the user account (120), and receiving customizable information (130) would be unnecessary.

The depicted method includes the step of receiving a search query (140). The received search query can be input using any manner of networked device, as described previously, and can include any number of search terms, fields, flags, categories, or other elements usable to search the stored items and retrieve responsive results. Items responsive to the search query are then displayed (150). Displaying of the responsive items can include use of any display device integrated with or in direct or remote communication with the device used to provide the search query. The items displayed can include individual items or groupings of items, such as recipes. The items can be displayed in any format or order, including ordering the items alphabetically, by price, by favoring manufacturers who have paid a premium, or other similar orders.

The method then includes the step of receiving selection of one or more items (160). Selection can be performed using any input device integral with or in communication with the device used to provide the search query, and can include selection of any number of items. The selected items can be stored, locally or remotely, to form a virtual shopping list.

It should be understood that the steps of receiving a search query (140), displaying responsive items (150), and receiving selection of items (160) can be repeated as many times as necessary, until all desired items for purchase have been located and selected.

Once an item has been selected, one or more corresponding discounts are automatically associated with the selected items (170). This step can be performed invisibly and seamlessly, without requiring intermediate action by a user, however in an embodiment of the invention, the corresponding discounts and related information can be displayed.

The corresponding discounts are then applied to the selected items as the purchase is completed (180). Completion of the purchase can include locating the selected items at a store and processing the items using store equipment or providing the selected items to a cashier or other store employee. The store equipment or store employee can be provided with a transaction identifier, user account information, or a portable device used to select the items to enable processing of the associated discounts.

The present system and method thereby combine an expansive and customizable Internet-based community with the incentive of an automatic system for discounting purchases through a completely paperless process, in a flexible, simple, efficient, and easy-to-use manner, while benefitting from the efficiencies of third-party access to provide updated information and the demographic tracking potential of the Internet.

While various specific embodiments of the invention have been described with emphasis, it should be understood that within the scope of the appended claims, the present invention can be practiced other than as specifically described herein.

What is claimed is:

1. A method for automatically discounting a purchase at a location, the method comprising the steps of:
receiving a search query from a user using a device in communication with a database comprising a plurality of items and a plurality of discounts associated with the plurality of items;
transmitting to the device at least one item of the plurality of items responsive to the search query for display;
receiving a selection of said at least one displayed item from the user using the device;
automatically associating at least one corresponding discount of the plurality of discounts with said at least one selected item; and
automatically applying said at least one corresponding discount to said at least one selected item when said at least one selected item is purchased.

2. The method of claim 1, further comprising the step of receiving at least one discount of the plurality of discounts from at least one third party responsible for availability, provision, sale, or distribution of at least one corresponding item and storing said at least one discount in the database for automatic association with and application to said at least one corresponding item when said at least one corresponding item is purchased.

3. The method of claim 1, wherein the search query comprises a search for a group of items, and wherein the step of transmitting to the device said at least one item comprises displaying a list of items contained within the group of items.

4. The method of claim 1, wherein the search query comprises a search for an event, the method further comprising the step of transmitting to the device at least one item corresponding to the event, at least one group of items corresponding to the event, or combinations thereof.

5. The method of claim 1, further comprising the step of transmitting to the device at least one advertisement for display, said at least one advertisement corresponding to at least one selected item of the plurality of items, at least one third party related to said at least one selected item of the plurality of items, or combinations thereof.

6. The method of claim 5, wherein said at least one advertisement comprises a textual advertisement, a graphic advertisement, a query enabling the user to provide selection of said at least one selected item, or combinations thereof.

7. The method of claim 1, wherein the step of transmitting to the device said at least one item comprises transmitting for display a list of items responsive to the search query wherein the list of items is ordered in a manner selected from the group consisting of: items provided by third parties that have paid a premium before other items, items in order of decreasing advertising dollars received from third parties, items in order determined by price accounting for said at least one corresponding discount, items in an order determined by the user or a group of users, and combinations thereof.

8. The method of claim 1, further comprising the step of transmitting for display on the device said at least one corresponding discount associated with said at least one item.

9. The method of claim 1, further comprising the steps of accepting account information from the device, accepting selected information from the device, storing the selected information in the database in association with the account information, thereby forming a user account, accepting identifying information from the device for accessing the user account, and accepting a selection of at least one item of the selected information to be made accessible to other users.

10. The method of claim 9, wherein the selected information comprises at least one item from the database, at least one group of items from the database, at least one item of personal information, or combinations thereof.

11. The method of claim 9, further comprising the step of accepting a communication from a first user and storing the communication in association with account information of a second user.

12. The method of claim 9, wherein said at least one corresponding discount is provided by a third party, the method further comprising the step of transmitting account information of the user to the third party after automatically applying said at least one corresponding discount to said at least one selected item.

13. The method of claim 9, further comprising the step of providing at least one automatic notification to be stored in association with the user account based on the selected information from the user.

14. A system for automatically discounting a purchase, the system comprising:
a database comprising:
a plurality of items for purchase;
a plurality of discounts, wherein each discount of the plurality of discounts is associated with at least one item of the plurality of items;
a plurality of account information, wherein each item of account information of the plurality of account information is associated with a user;
a plurality of stored information, wherein each item of stored information of the plurality of stored information is associated with the user;
computer instructions for receiving a search query and transmitting said at least one item of the plurality of items responsive to the search query;
computer instructions for receiving a selection of said at least one item;
computer instructions for automatically associating and applying at least one corresponding discount of the plurality of discounts to said at least one item;
at least one networked device in communication with the database for providing search queries and providing and modifying said items of account information, said items of stored information, or combinations thereof; and
at least one administrative device in communication with the database for providing and modifying the plurality of items, the plurality of discounts, or combinations thereof.

15. The system of claim 14, wherein the plurality of discounts comprises discounts provided by the location, discounts provided by at least one third party responsible for providing at least one of the items, or combinations thereof.

16. The system of claim 14, wherein the plurality of stored information comprises at least one selected item or group of items, at least one item of personal information, or combinations thereof.

17. The system of claim 14, wherein the database further comprises personal information of the user, a plurality of demographic information related to the user, items purchased by the user, discounts used by the user, favorite products of the user, or combinations thereof.

18. The system of claim 14, wherein the database further comprises a plurality of groups of items, wherein each group of the plurality of groups of items is associated with at least one item of the plurality of items.

19. The system of claim 14, wherein the database further comprises advertising information relating to said at least one item of the plurality of items, at least one third party associated with said at least one item, or combinations thereof.

20. The system of claim 14, wherein the database further comprises computer instructions for ordering results of the search query in a manner selected from the group consisting of: items provided by third parties that have paid a premium before other items, items in order of decreasing advertising dollars received from third parties, items in order determined by price accounting for said at least one corresponding discount, items in an order determined by a group of users, and combinations thereof.
